(19) United States
(12) Patent Application Publication
(10) Pub. No.: US 2024/0015568 A1
(43) Pub. Date: Jan. 11, 2024

(54) CONTEXTUAL QUALITY OF SERVICE FOR MOBILE DEVICES

(71) Applicant: QUALCOMM Incorporated, San Diego, CA (US)

(72) Inventors: Ashok BHATIA, San Diego, CA (US); Vijayalakshmi RAVEENDRAN, Del Mar, CA (US)

(21) Appl. No.: 18/338,476

(22) Filed: Jun. 21, 2023

Related U.S. Application Data
(60) Provisional application No. 63/359,714, filed on Jul. 8, 2022.

(51) Int. Cl. H04W 28/02; H04B 10/11; H04B 11/00; H04W 28/08

(52) U.S. Cl. CPC H04W 28/0268; H04B 10/11; H04B 11/00; H04W 28/0967

(57) ABSTRACT

Techniques are provided for enabling contextual Quality of Service (QoS) of mobile services. An example method of generating an output based on a contextual quality of service includes obtaining an input with a device module, determining a context indicator based on the input, determining a quality of service based at least in part on the context indicator, and generating the output based at least in part on the input and the quality of service.

### CROSS-REFERENCE TO RELATED APPLICATION

This application claims the benefit of U.S. Provisional Application No. 63/359,714, filed Jul. 8, 2022, entitled “CONTEXTUAL QUALITY OF SERVICE FOR MOBILE DEVICES,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

Electronic devices capable of utilizing such wireless communication systems have become practically ubiquitous in modern society. Some electronic devices (e.g., cameras, video camcorders, digital cameras, cellular phones, smartphones, computers, televisions, gaming systems, etc.) utilize one or more sensors. For example, a smartphone may capture digital images utilizing an image sensor module, record sounds with an audio module, and determine a location with a navigation module. The extensive capabilities of such electronic devices in combination with a communication network may create personal privacy and copyright infringement issues. For example, such electronic devices may be used to record copyrighted material, or obtain an unauthorized photograph of a person and then utilize a communication system to publish the captured information in a public forum. Systems and methods that protect personal privacy may be beneficial.

### SUMMARY

An example method of generating an output based on a contextual quality of service according to the disclosure includes obtaining an input with a device module, determining a context indicator based on the input, determining a quality of service based at least in part on the context indicator, and generating the output based at least in part on the input and the quality of service.

An example method for providing contextual quality of service information according to the disclosure includes detecting a context condition associated with a user equipment, determining one or more context indicators and quality of service rules based at least in part on the context condition, and providing contextual quality of service information to the user equipment including the one or more context indicators and quality of service rules.

An example method of operating a mobile device according to the disclosure includes determining an operational context for the mobile device based at least in part on a location of the mobile device, one or more preferences associated with a user of the mobile device, and a context indicator detected by one or more modules in the mobile device, and enabling or disabling one or more capabilities of the mobile device based on the operational context.

Items and/or techniques described herein may provide one or more of the following capabilities, as well as other capabilities not mentioned. Mobile devices, such as smart phones, WiFi devices, drones, robots, etc., may include different modules configured to obtain and process various inputs such as images, audio and radio frequency signals. The quality of outputs generated based on the inputs may vary. For example, the resolution of a captured image may vary or the resulting accuracy of a position estimate based on received navigation signals may be increased or decreased. These variations on the quality of service (QoS) may be based on a current context associated with the mobile device. In an example, the mobile device may detect one or more context indicators when obtaining an input. Quality of service rules may be associated with the context indicators. Other user and operator preferences may also impact the quality of service rules. In operation, the quality of an output from a module may be based at least in part on the context indicators detected by the module. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment.

FIG. 3 is a block diagram of components of an example transmission/reception point.

FIG. 4 is a block diagram of components of a server.

FIG. 5 is a block diagram of example modules in a user equipment.

FIG. 6 is a block diagram of an example process for implementing context based quality of service.

FIGS. 7A-7C are diagrams of example use cases for applying quality of service rules on optical inputs.

FIG. 8 is a diagram of an example use case for applying quality of service rules on audio inputs.

FIG. 9 is a diagram of an example use case with a personal context indicator.

FIG. 10A is a diagram of an example use case for limiting the distribution of confidential presentations.

FIG. 10B is a diagram of an example use case for limiting the distribution of content in virtual meetings.

FIG. 11 is a diagram of an example use case for applying quality of service rules on navigation inputs.

FIG. 12 is a block diagram for implementing context based quality of service rules on a user equipment.

FIG. 13 is an example data structure for implementing context based quality of service rules.

FIG. 14 is an example message flow diagram for providing contextual quality of service information to a user equipment.

FIG. 15 is a process flow diagram for an example method for providing contextual quality of service information.

FIG. 16 is a process flow diagram for an example method for generating an output based at least in part on contextual quality of service information.

FIG. 17 is a process flow diagram for an example method for enabling or disabling one or more capabilities of a mobile device.

### DETAILED DESCRIPTION

Techniques are discussed herein for enabling contextual Quality of Service (QoS) of mobile services. In general, the term contextual QoS may mean the automatic and dynamic adjustment of the QoS of modules on a mobile device, based on context and without manual intervention from an end user. A context of a mobile device may be a dynamic measure of an end-user's current activity, based on which either the end user or a stakeholder in the mobile eco system may want a mobile device to perform differently. Examples of context include, but are not limited to, time of the day, location information (e.g., a user at a certain location/within a geofence), end user activity (e.g., walking, driving, running, sleeping, on a phone call, etc.), applications executing on the mobile device, multimedia content being played on or near the mobile device, listening to specific audio clips/songs etc., using the mobile phone camera to take a picture of a specific object, etc. A context may be based on environmental conditions and/or environmental triggers such as detecting if a mobile device is in a crowded area, in the geographic area of a natural or man-made disaster, or in the coverage areas of a certain private networks, or certain WiFi Access points, Bluetooth (BT) beacons, etc. A QoS may be the quality of service provided by the modules (e.g., hardware and/or software), or other services provided through a mobile device. In general, QoS adjustments cause a different quality than the normal expectation, including disablement of certain services. For example, a location services QoS adjustment may cause end user applications to receive reduced position accuracy, an incorrect location, or denial of a location estimate. A camera QoS adjustment may reduce picture quality (e.g., reduce resolution, dither, watermark, etc.), or prohibit a camera from obtaining an image. An audio QoS adjustment may degrade the quality of an audio recording and/or playback (e.g., reduce sample rate, limit audio bandwidth, clip frequencies, etc.), or disable audio recording. Other contexts and QoS modifications may also be used.

In an example, operators of wireless local area networks (WLANs) and wireless wide area networks (WWANs) may establish context conditions to enable mobile devices, such as user equipment (UE), to obtain context indicators associated with anticipated use cases. In general, the context indicators may be associated with external inputs and/or device state information and a QoS rule. For example, in an optical QoS based use case, a museum owner may desire to constrain the ability of guests to obtain photographs of art on display in the museum. A context condition may include entering a geofence associated with the museum, obtaining an electronic museum admissions ticket, scheduling a visit at the museum, detecting a WiFi network associated with the museum, or other action indicating that a user may have visual access to the art on display in the museum. In response to detecting a context condition, the mobile device may obtain (or a network server/other resource may provide) data including one or more context indicators. In this use case, the context indicators may include data files to enable the mobile device to visually recognize the art on display and then apply QoS rules when an image of the art is obtained by the mobile device. The context indicators are configured to modify the QoS of a module obtaining the input. Optical based context indicators are used for optical inputs, audio based context are used for audio inputs, navigation based context indicators are used for navigation inputs, communication based context indicators are used for communication inputs, etc. Mixed context indicators may also be used. For example, an audio based context may be used to limit a video recording capability. Other environment factors, such as the presence of a certain WiFi signals may be used as a context indicator and may impact the functionality of one or more modules in a mobile device. In a use case, when the user obtains an image with the optical module on the mobile device, the mobile device is configured to perform an image recognition process on the obtained image and determine whether there is a match with the context indicators received from the network. If a match is detected, the mobile device is configured to change the QoS of the obtained image. An image file obtained by the camera may be transformed. The resolution of the saved image may be at a reduced level (e.g., low resolution), portions of the image may be redacted, the resulting image file may be watermarked (e.g., with a digital rights management (DRM) feature), and/or experience other modifications to the quality of the obtained image. In an example, the mobile device may be prevented from obtaining the image. Other factors, such as user preferences/privileges and/or network operator configuration options, may also impact the resulting QoS. For example, a museum may enable devices associated with donors or preferred members to obtain images of some art at a first QoS, while unaffiliated museum visitors may be allowed to obtain images of the art at a second QoS. The visual based context indicators in this use case are examples, and not limitations, as context indicators and QoS rules may be associated with other modules and other inputs. Other module configurations may also be used.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile device, mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

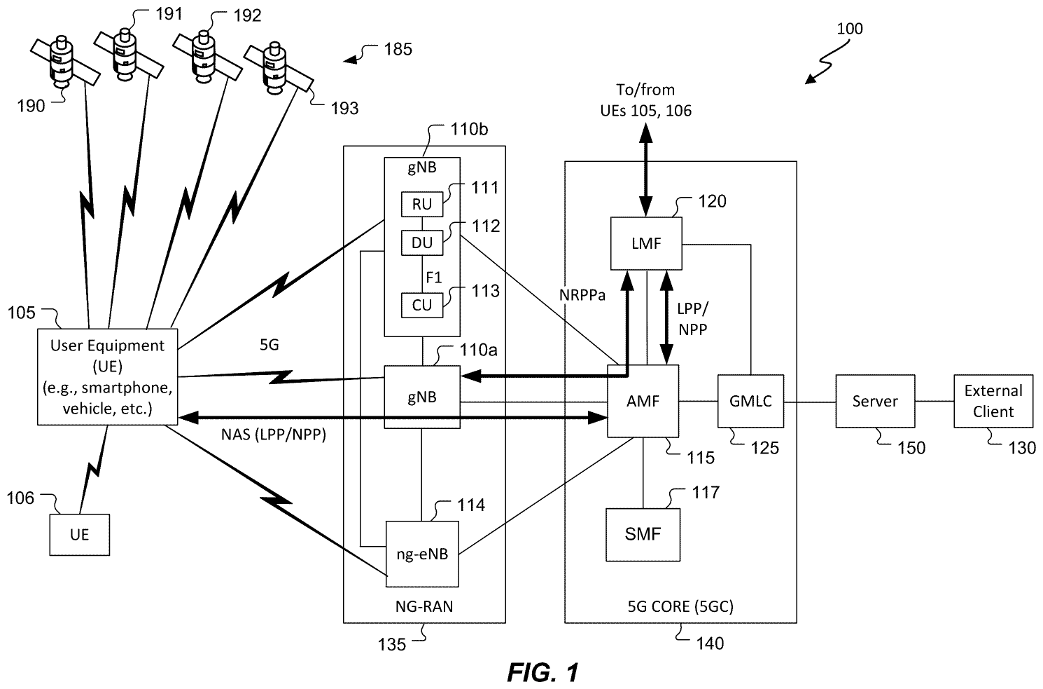

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNB s 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNB s. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional positioning reference signals (PRSs) may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

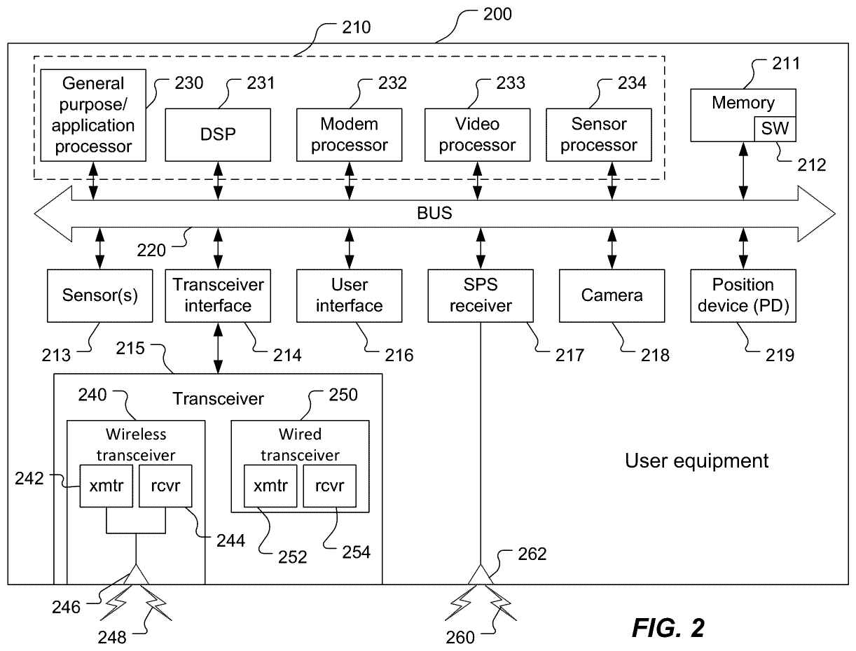

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 217, and/or another component of the UE 200, and may be provided by hardware, software, firmware, or various combinations thereof.

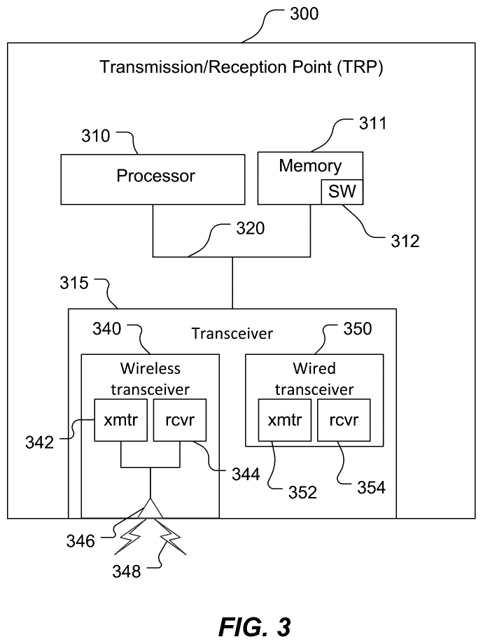

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

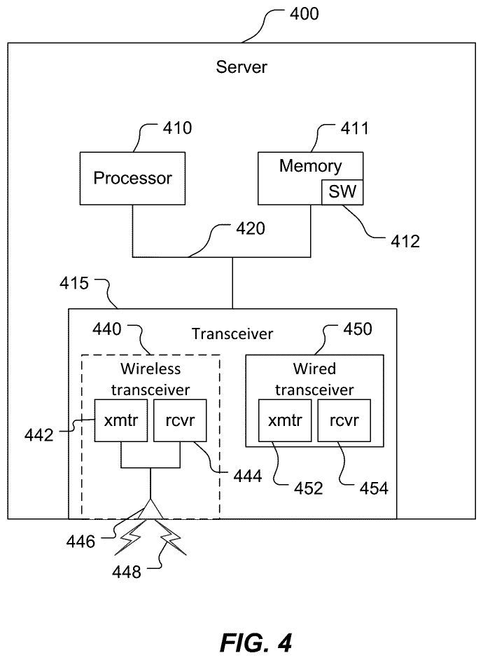

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

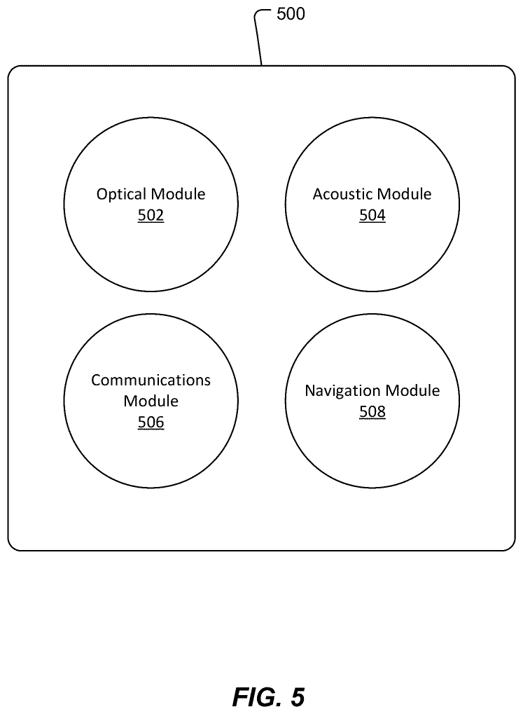

Referring to FIG. 5, a block diagram of example modules in a user equipment 500 is shown. The UE 500 may include some or all of the components of the UE 200, and the UE 200 is an example of the UE 500. The UE 500 includes different modules for different capabilities. The example modules may include an optical module 502, an acoustic module 504, a communications module 506, and a navigation module 508. Each of the example modules 502, 504, 506, 508 includes the hardware and software components to enable the respective functionality of the modules. For example, the optical module 502 includes components to obtain and process image information, such as the camera 218, the video processor 233, and other such hardware and software components. In an example, the optical module 502 may include one or more visual light, infrared sensors, or other optical based sensors. The acoustic module 504 includes hardware and software components, such as microphones, speakers, and processors associated with the user interface 216 and the processors 210, to enable the UE 500 to obtain and process acoustic inputs. The communications module 506 includes hardware and software, such as a transceiver 215, a transceiver interface 214, a modem processor 232, or other components to enable the UE 500 to communicate with other stations. The navigation module 508 includes hardware and software, such as the SPS receiver 217, the transceiver 215, sensors 213, and other components to enable the UE 500 to obtain position information. The components of the modules and corresponding functionality may vary based on the hardware and software configuration of the UE 500. Each of the modules 502, 504, 506, 508 may be configured to detect context indicators and apply QoS rules to their respective outputs based at least in part on the context indicators.

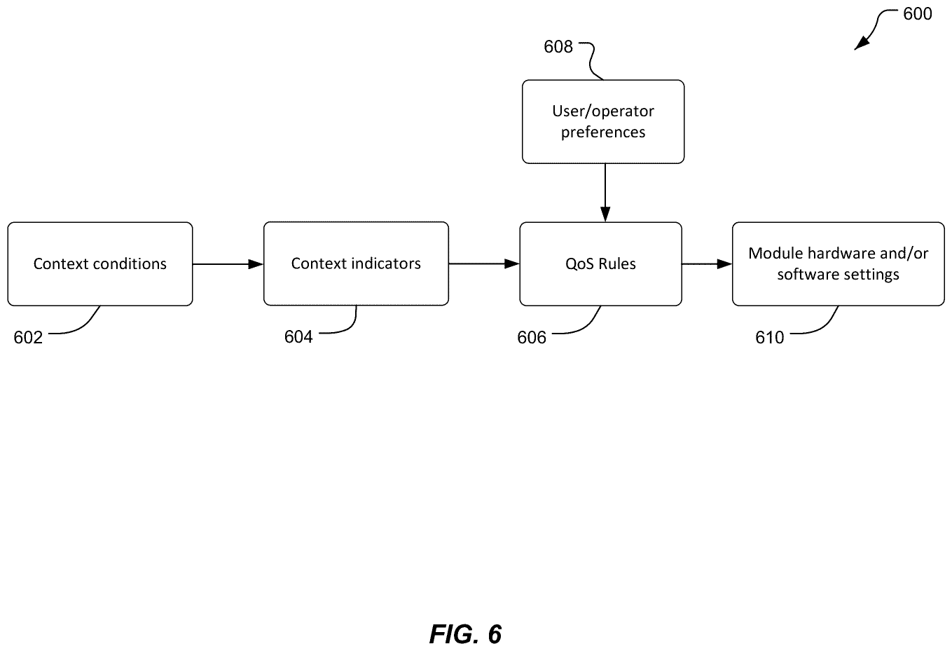

Referring to FIG. 6, a block diagram of an example process 600 for implementing context based quality of service is shown. The process 600 is applicable to many different use cases based on the capabilities of a network and a UE. In general, the context conditions 602 may be used to establish an entry point for a contextual QoS use case. The context conditions 602 may be relatively broad conditions which may be used to anticipate that a mobile device may be operating within a particular contextual QoS use case. The context indicators 604 may be associated with one or more context conditions 602. The QoS rules 606 may be applied based on when one or more context indicators 604 are detected by a mobile device. User and/or network operator preferences 608 may impact on the application of the QoS rules 606. For example, the user/operator preferences 608 may include privileges associated with a user. The QoS rules 606 may impact module hardware and/or software settings 610. The following use cases are provided as examples of how the process 600 may be implemented.

In a location services use case, the quality of a position estimate may be reduced for some users. For example, when in the geofence of the campus of an organization, only some authorized end user devices, and/or specific applications executing on a mobile device may obtain an accurate location. Conversely, other users and other applications may obtain lower accuracy (or incorrect) location estimates. In this use case, example context conditions 602 may include being a current employee or student, or being located within an area which also includes the campus. Example context indicators include being within one or more defined geofence areas. The QoS rules may be configured to reduce the accuracy of position estimates computed by the navigation module 508.

In an acoustic use case, the quality of an audio recording may be reduced for some users. For example, when a new song is released by a popular singer, during the first week of the song's release an attempt to record the song using a mobile device may result in a low quality recording. Other songs, however, may be recorded normally during this period. In this use case, example context conditions 602 may include one or more of a date the song is released, a duration of time, being located at a venue where the song is being played, or purchasing a ticket to attend such a venue. Example context indicators 604 include obtaining a recording of the song, and the QoS rules 606 may include degrading a microphone input during recording and/or reducing the quality of the resulting media file (e.g., lower capture rate, clip acoustic range, etc.).

In an optical use case, the quality of a captured image may be reduced for some users. For example, a museum may desire to protect the copyrights of artwork on display in the visitor gallery. In this use case, when a user attempts to obtain a picture of the artwork with a mobile device, the camera flash may be automatically disabled, and/or picture quality may be significantly degraded/pixelized. The same mobile device, however, may obtain pictures of other artwork in the museum. In this use case, example context conditions may include being located at the museum, purchasing a ticket to visit the museum, or detecting a WiFi signal within the museum. Examples of the context indicators 604 may include an image of the artwork within the camera frame, or other visual indicators which may be captured by the optical module in the mobile device. The QoS rules 606 may include disabling the flash, reducing the resolution of the obtain image, and/or redacting at least a portion of the image captured by the mobile device. These use cases are examples, and not limitations as the process 600 may apply to other contexts and associated QoS rules for controlling the functionality of a mobile device based at least in part on the context indicators.

In an example, the context conditions 602, the context indicators 604, QoS rules 606, the user/operator preferences 608 and the module hardware and/or software settings 610 may be included in software application installed on a mobile device. For example, a user may install an application (e.g., an App) from an online service which includes the context and rules information. In an example, the application may be configured to obtain the context and rules information from a networked data source, such as a remote server. Other generic software loading techniques, such as wired or wireless connections to a network computing device may be used to obtain software files and install the context and rule information onto a mobile device.

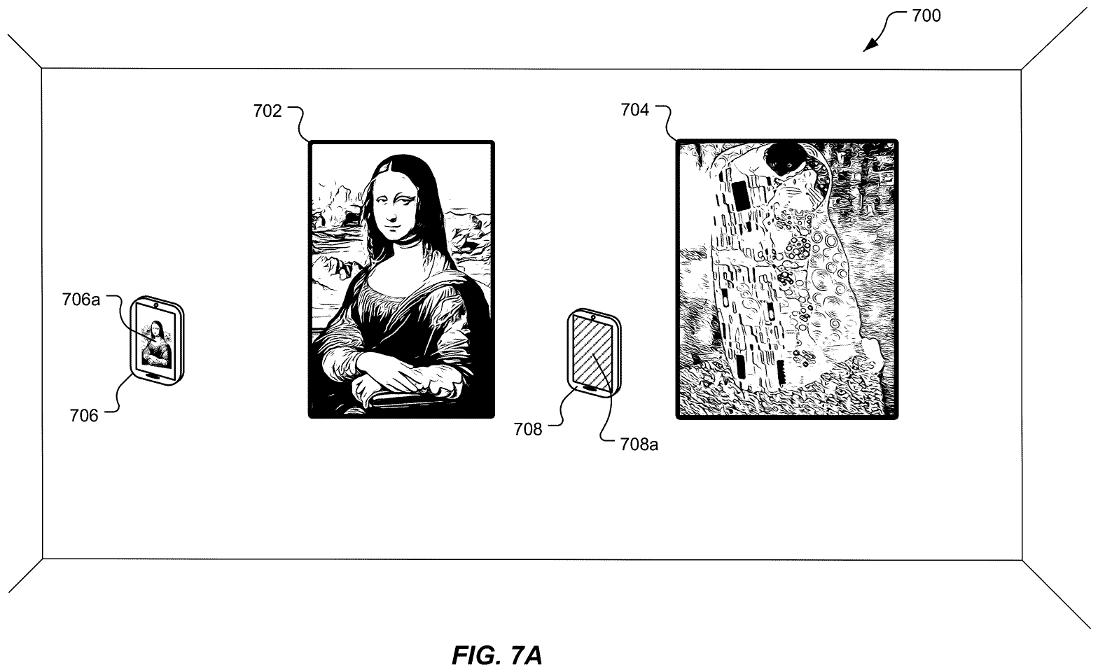

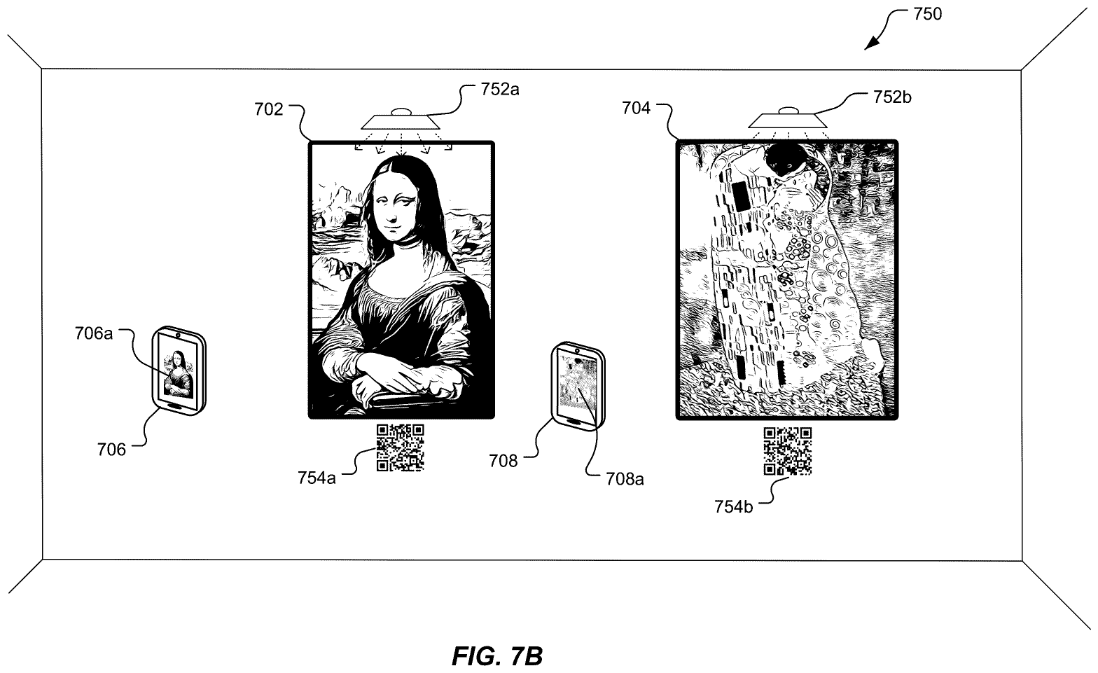

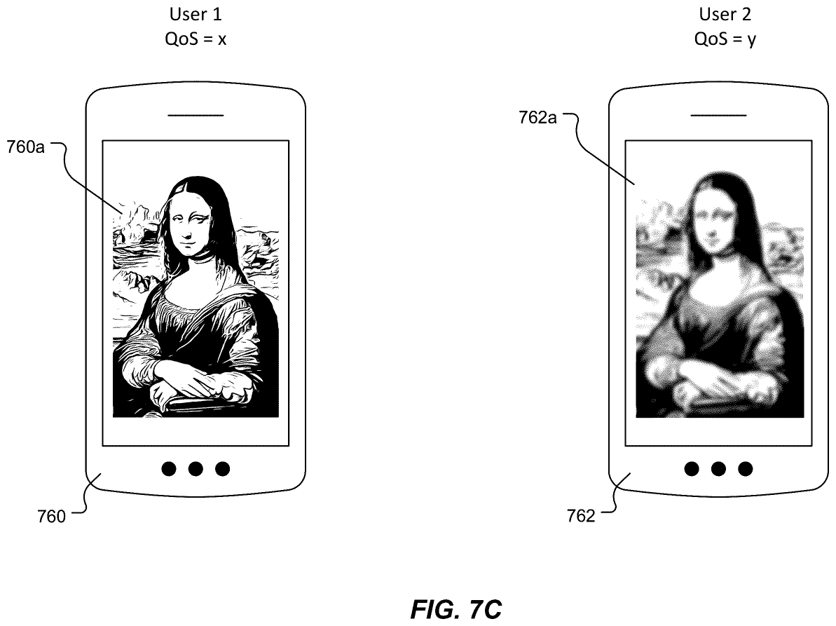

Referring to FIGS. 7A-7C, diagrams of example use cases for applying quality of service rules on optical inputs is shown. FIG. 7A depicts an example museum wall 700 displaying a first painting 702 and a second painting 704. A first user (not shown in FIG. 7A) is utilizing a first UE 706 to obtain an image of the first painting 702, and a second user (not shown in FIG. 7A) is utilizing a second UE 706 to obtain an image of the second painting 704. In an example, a network server (or other resource) may be configured to detect context conditions for the UEs 706, 708, such as determining when the UEs 706, 708 are located in the museum or proximate to the wall 700. The network server may be configured to send context indicators to the UEs 706, 708, such as image data files to enable the UEs 706, 708 to perform an image recognition on the paintings 702, 704. For example, the context indicators may be provided in response to detecting the context conditions. The museum operators may establish QoS rules such that all devices are allowed to photograph the first painting 702, but photographing the second painting 704 is prohibited. Other variations of rules for combinations of users and paintings may also be used (e.g., some users may photograph some paintings), and the corresponding QoS results may also be varied (e.g., some users may photograph some paintings at a reduced resolution, etc.). The first UE 706 may be configured to obtain a first image 706a of the first painting 702 and may utilize the resulting image file without restriction. In contrast, the second UE 708 attempts to photograph the second painting 704 but the UE 708 displays a blank or redacted image 708a. That is, the image 708a is at a reduced QoS because the second painting 704 is a context indicator. While FIG. 7A depicts the image 708a as redacted, other QoS rules may be applied. For example, the resolution of the image 708a may be reduced, the colors may be modified, or DRM features could be included in the resulting image file. In an example, the flash on the second UE 708 could be disabled, or the record functions on the optical module may be disabled when the second painting 704 is within the camera view. Other QoS rules 606 may also be applied based on the context indicators 604 and user/operator preferences 608 associated with the museum and/or the user (e.g., if the user is a VIP donor to the museum).

FIG. 7B includes examples of other context indicators which may be detected by optical modules of the UEs 706, 708. In general, the context indicators include features which may be detected by the impacted module. In an implementation, context indicators may be features detected by one module which may impact different modules, components or processes. For example, detection of a certain WiFi signal may impact the functionality of one or more modules. In the optical input use case in FIG. 7B, a museum wall 750 may include context indicators such as lamps 752a-b and quick response (QR) codes 754a-b. For example, the lamps 752a-b may be configured to emit a specific frequency of light (e.g., UV, visible, IR) which is detected by the optical modules in the UEs 706, 708. In an example, the lamps 752a-b may be configured for Visible Light Communication (VLC) using light emitting diodes (LEDs), and the UEs 706, 708 may be configure to decode the respective VLC signals emitted by lamps 752a-b. The first lamp 752a may emit a first VLC signal as a context indicator for the first painting 702, and the second lamp 752b may emit a second VLC signal as a context indicator for the second painting 704. Other optical based technologies may be used as context indicators. For example, the first QR code 754a may be a context indicator for the first painting 702, and the second QR code 754b may be a context indicator for the second painting 704. The quality of the images 706a, 708a may vary based on the context indicators and the QoS rules.

Referring to FIG. 7C, example images based on different QoS rules are shown. A first user may be associated with a first UE 760 and a second user may be associated with a second UE 762. The first UE 760 obtains an image of a painting (e.g., the first painting 702) and the resulting first image 760a is at a standard quality. The first and second users may be associated with different preferences. For example, the first user may be a donor to the museum, or may have paid for a subscription, or may have satisfied another condition established by the network operators, to enable a first QoS rule to be applied when the first user obtains an image of the first painting 702. In contrast, when the second UE 762 obtains an image of the first painting 702, the resulting second image 762a is at a lower quality as compared to the first image 760a (e.g., the second image 762a is blurry). For example, the second user may not have the credentials of the first user and thus the QoS rules for the two users may be different. In an example, the context indicators and QoS rules may be provided by the network operator when the context conditions are detected.

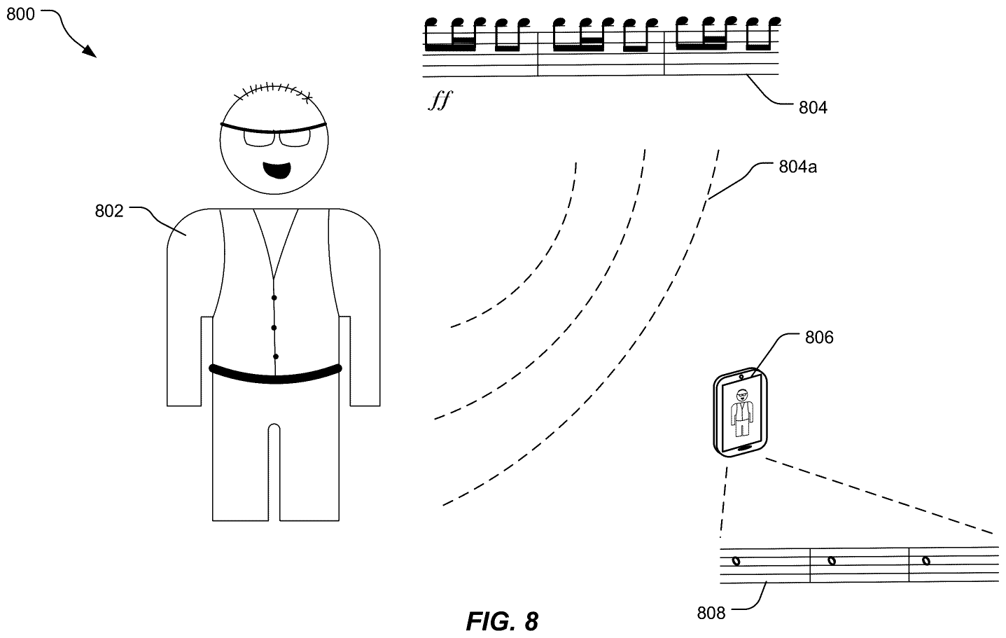

Referring to FIG. 8, a diagram 800 of an example use case for applying quality of service rules on audio inputs. The diagram 800 depicts a performer 802 who is providing an audio signal in the form of a song 804. A UE 806 includes an acoustic module 504 with a microphone and is configured to receive the acoustic input 804a and save a recorded audio as part of an audio and/or video file. In this use case, the performer 802, or other entity, may desire to limit the ability of a user to obtain and save audio recordings of their performances. The context based QoS process 600 may be utilized to modify the audio recording such that the UE 806 saves an audio file (or audio track of a video file) as a low fidelity recording 808. For example, the context conditions 602 for this use case may include the current location of the UE 806 (e.g., being proximate to the performer 802), or purchasing a ticket to the performance. An audio component such as the song 804 may be a context indicator 604. For example, the UE 806 may be configured with a music recognition algorithm (e.g., MusicID, Shazam, etc.) and data files associated with the song 604 may be provided to the UE 806 based on the context conditions 602. The QoS rules 606 may be configured to reduce the fidelity of the microphone and/or resulting audio file (e.g., clip the range, reduce the sample rate, watermark with a tone, etc.), or prohibit the recording entirely. In an example, user/operator preferences 608 such as VIP status, or an indication the a user has purchased an album, may also be used to modify the QoS rules 606. Other user and operator preferences may also be used to impact the QoS of the resulting audio file. Other context indicators may also be used. For example, sub-audio tones or high frequency tones (e.g., outside of human hearing) may be detected by the acoustic module 504 and used as a context indicator for an audio use case.

In an example, the QoS rules may invoke known audio watermarking techniques. For example, speech samples in audio/songs may be mixed in the recorded speech. These speech samples may be outside the audible frequency range for a normal human ear, or encoded in a way such that the speech is not recordable when played. The presence of this watermark can be determined in the a trusted context engine (TCE) in the UE 806. When the TCE detects these signals, the TCE may add a speech signal pattern, or introduce some degradation in the audio recording path, which makes the recording quality to be very poor or completely inaudible.

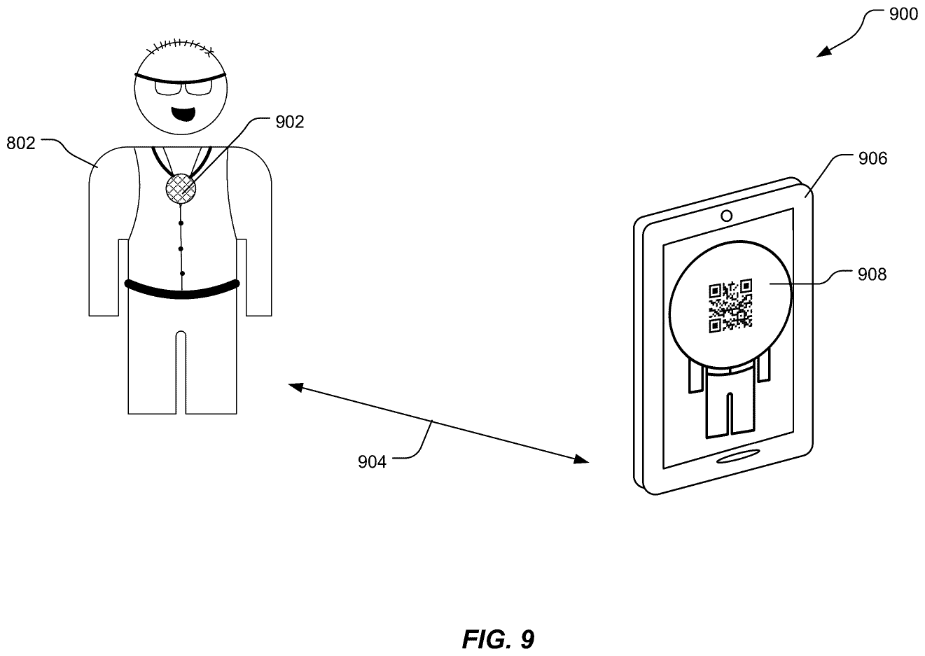

Referring to FIG. 9, a diagram 900 of a use case with a personal context indicator is shown. The performer 802, or other individual, may desire to protect their privacy by limiting the ability of others to obtain a photograph of them. For example, the performer 802 may be located in a venue with an expectation of privacy. The performer 802 may wear a personal context indicator 902 to enable QoS rules on mobile devices attempting to obtain a photograph or video with the performer 802 in the frame. The personal context indicator 902 may be an item such as a badge, neckless, patch, arm band, glasses, or other wearable item which may be detected by an optical module on a UE. The personal context indicator 902 may be a symbol, QR code, interference pattern, or other visual object that may be recognized by an optical module in a UE. In an example, the personal context indicator 902 may be a LED or other light source configured to emit a VLC code. Other wearable emitters, such as RF, IR, and UV sources, and other machine-readable information which may be detected by a UE may also be used as a personal context indicator 902. In an example, facial recognition techniques may be used such that the face of the performer 802 may be used as a context indicator.

In this example use case, a distance 904 between the performer 802 and a UE 906 may be utilized as a context condition. Other context conditions, such as scheduling information, detected sidelink signals, common serving stations, etc. may also be used to anticipate that the UE 906 is in a position to obtain a photograph or video of the performer 802. When the UE 906 detects the personal context indicator 902, the corresponding QoS rules may cause the display 908 (and resulting captured image) to be redacted. In an example, the center of the redaction may be based on the location of the personal context indicator 902 in the image. Other QoS rules, such as reducing the resolution of a captured image, watermarking a captured image, or disabling the camera may be used. The QoS rules may also be configured to embed information in a captured image based on detecting the personal context indicator 902. For example, a URL address, personal message, QR code, or other information may be displayed with, or in place of, an image of the performer 802. Other QoS rules and corresponding hardware and/or software settings may be used to preserve the privacy of the performer 802.

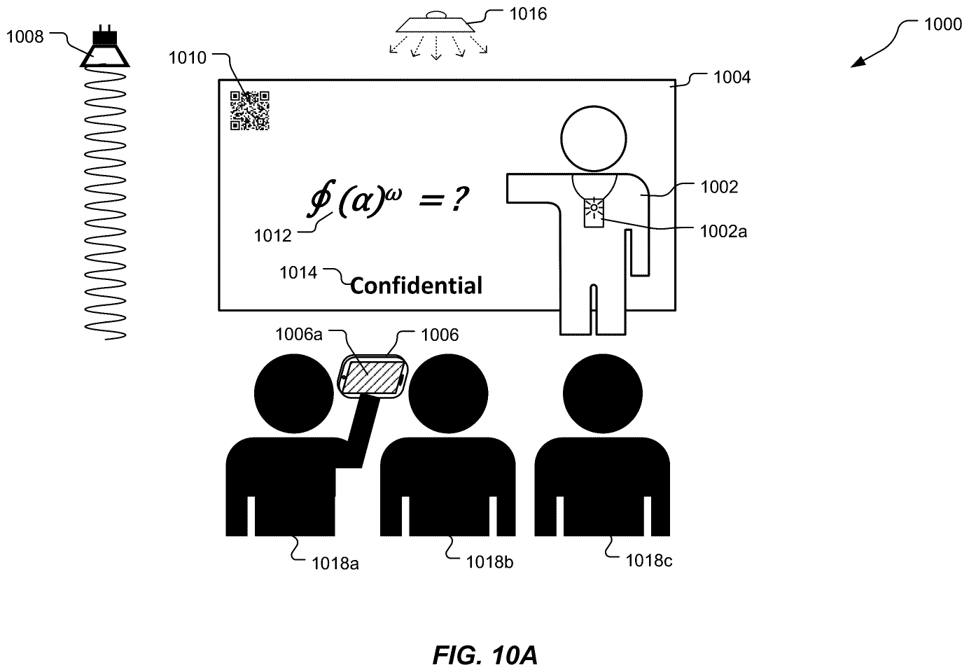

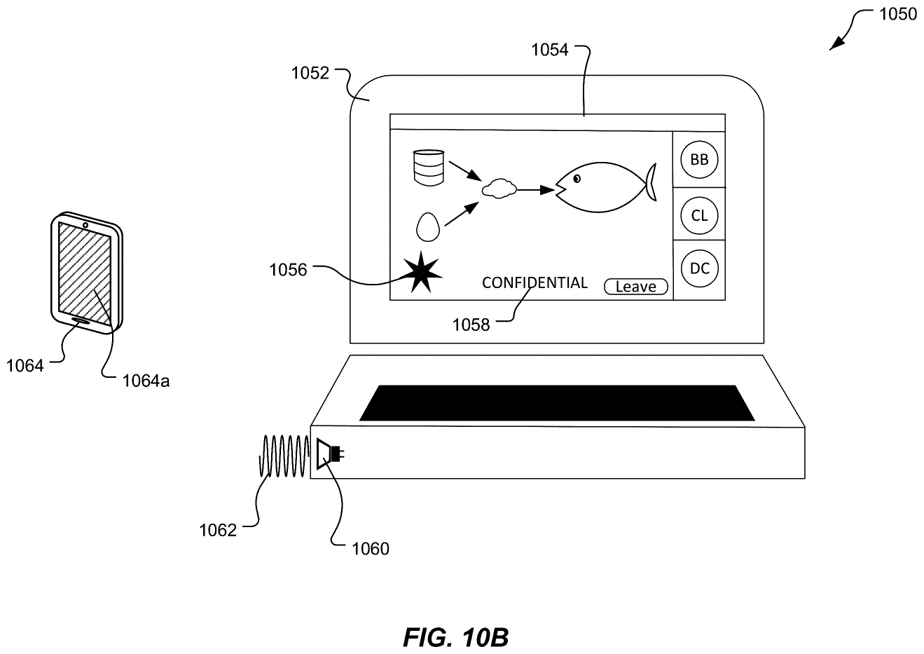

Referring to FIG. 10A, a diagram 1000 of an example use case for limiting the distribution of confidential presentations is shown. The diagram 1000 includes a presenter 1002, a presentation medium 1004 and an audience 1018a-c. A first audience member 1018a is attempting to record the presentation with a UE 1006. The diagram 1000 includes a plurality of example context indicators including a QR code 1010 disposed on the presentation medium 1004, a light fixture 1016, and a plain text indicator 1014 disposed on the presentation medium 1004. The light fixture 1016 may be configured to emit a VLC signal as the context indicator, and/or emit other optical properties that are detected by the camera module on the UE 1006. The presenter 1002 may utilize a personal context indicator 1002a to enable QoS rules for a presentation. The plain text indicator 1014 may be text included in the presentation (e.g., in a slide of a presentation file, handwritten on the presentation medium 1004) and the UE 1006 may be configured to perform an optical character recognition (OCR) process on the plain text indicator 1014 to enable the QoS rules. When the presentation medium is a whiteboard, the presenter 1002 may write one or more context words (e.g., confidential, secret, noforn, top secret, etc.) on the whiteboard, or include the context words in an electronic presentation. Different context words may be used to invoke different QoS rules. In an example, features of the presentation such as the color and/or font of text 1012 in the presentation may be used as a context indicator. Other context indicators may also be used to limit the QoS of other modules in the UE 1006. For example, sub or super audible tones (i.e., below or above the audible range of human hearing) may be emitted from a speaker 1008 as a context indicator for an acoustic module in the UE 1006.

In this presentation use case, the proximity of the UE 1006 to the presentation medium 1004, or the presenter 1002 may be used as a context condition. Other context conditions may also be used, such as being an employee of a company (e.g., having access to the presentation), or visiting a corporate campus (e.g., visitor badge procedure), or other conditions which may be used to anticipate that a UE may have access to the presentation. While FIG. 10A depicts a plurality of example context indicators, only one context indicator is required to invoke the QoS rules. For example, when the UE 1006 obtains an image including the plain text indicator 1014 (e.g., the word confidential), the QoS rules may disable the optical module in the UE 1006 such that a blank image is presented on a display 1006a. Other QoS rules may also be used, and different users/UEs may have different QoS rules for the same context indicator.

Referring to FIG. 10B, with further reference to FIG. 10A, a diagram 1050 of an example use case for limiting the distribution of content in virtual meetings is shown. The diagram 1050 includes a computer 1052 configured with virtual meeting software 1054 (e.g., ZOOM, Microsoft Teams, etc.) to enable a user to view presentations provided by other users. The virtual meeting software 1054 and/or the media files being presented, may include one or more context indicators to limit the ability of a viewer to record the presentation with a UE 1064. An example context condition for a virtual meeting may be receiving the virtual meeting invitation. Example context indicators include a plain text indicator 1058 on images being presented, or an abstract context indicator 1056 such as a shape, QR code, window border, or other visual object which will be presented in the virtual meeting software 1054. As an example, and not a limitation, the abstract context indicator 1056 is depicted as a 7 point star in FIG. 10B and will remain on the screen throughout the virtual presentation. Other visual objects may also be used as abstract context indicators. The optical module in the UE 1064 is configured to detect the abstract context indicator 1056, or the plain text indicator 1058, and apply one or more QoS rules. For example, the QoS rules may cause an image 1064a obtained by the UE 1064 to be redacted or otherwise rendered useless. In an example, the virtual meeting software 1054 may be configured to utilize a speaker 1060 in the computer 1052 to emit an audio signal 1062 at the beginning of a presentation and/or periodically throughout the presentation. As a context indicator, the audio signal 1062 may be used to modify the QoS of an acoustic module in the UE 1064 for a period of time. For example, when the UE 1064 detects the audio signal 1062, the QoS of audio recording capabilities of the UE 1064 may be reduced for an hour (e.g., the scheduled length of the virtual presentation).

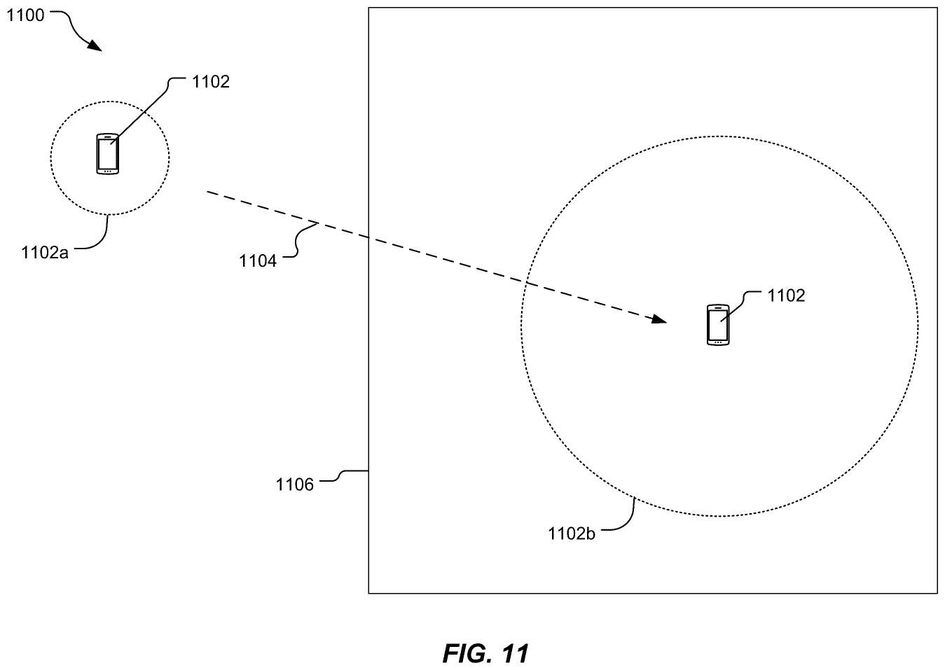

Referring to FIG. 11, a diagram 1100 of an example use case for applying quality of services rules on navigation inputs is shown. The diagram 1100 includes a UE 1102 moving along a path 1104 into a geofenced area 1106. In an example, the geofenced area 1106 may define a corporate or government campus with a desire to ensure that employee device location accuracy is low (so that for any application installed on an employee mobile device, it is difficult to exactly pin point where the employee is—even though it is possible to say that the employee is somewhere within the campus). The navigation module in the UE 1102 may be configured to provide a first position estimate 1102a with a first QoS when outside the geofenced area 1106, and a second position estimate 1102b with a second QoS when inside the geofenced area 1106. The first position estimate 1102a is more accurate than the second position estimate 1102b. In operation, a user may desire that all the location applications on the UE 1102 switch to low accuracy (or produce an incorrect location), during certain times of the day when they are in the geofenced area 1106. For example, a context condition may be the time of day, and the context indicator may be the current location of the user (e.g., the geofenced area 1106). In an example, UEs belonging to employees of an organization may have access restrictions (e.g., access to internet, documents, media files, etc.) when devices are in the geofenced area 1106, but devices belonging to non-employees will have regular access, even when they are within the geofenced area 1106. In an example, when the non-employee devices are within the geofenced area 1106, they should not be able to locate themselves (e.g., to prevent the exact location tagging of certain assets by non-employee devices).

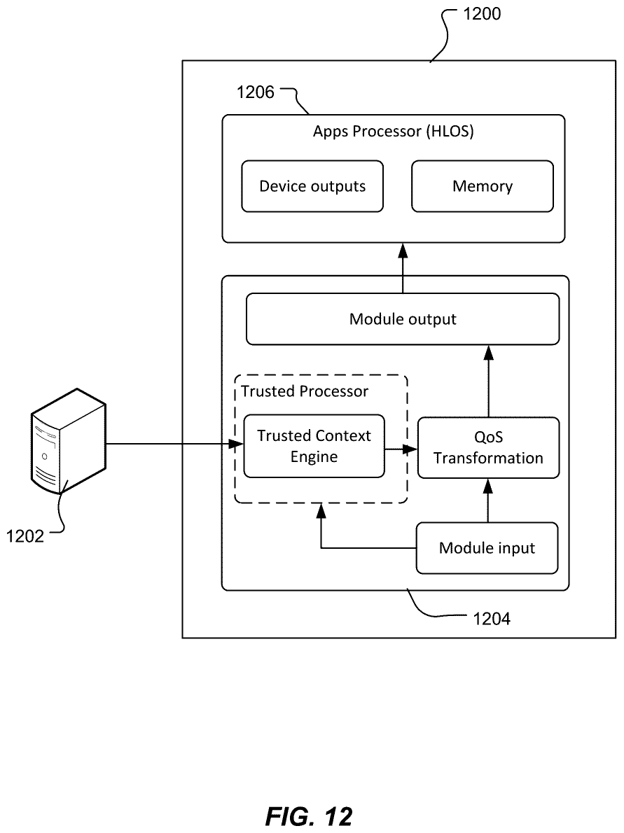

Referring to FIG. 12, a block diagram for implementing context based quality of service rules on a user equipment 1200 is shown. The UE 1200 may include some or all of the components of the UE 200, and the UE 200 may be an example of the UE 1200. The UE 1200 includes one or more modules 1204 such as the optical module 502, the acoustic module 504, the communications module 506 and the navigation module 508. A high level operating system (HLOS) 1206 may be configured to execute on one or more of the processors 210 and the memory 211. The module 1204 may also utilize one or more of the processors 210. In an example, the processors 210 may be configured as a trusted processor, such as an ARM Cortex processor with TrustZone technology. An edge server 1202 may be configured to provide context indicators and corresponding QoS rules to a trusted context engine with UE 1200. The edge server 1202 may be configured to communicate with the UE 1200 via the communication network 100. For example, the server 150 may be configured as the edge server 1202. Other communication techniques, such as WiFi and Bluetooth, may also be used to provide the context indicators and QoS rules to the UE 1200.

In operation, the UE 1200 may detect a context condition and request the context indicators and QoS rules from the edge server 1202. In an example, a network resource (such as the edge server, LMF, or other network entity) may detect the context condition and push the context indicators and QoS rules to the UE 1200. The context indicators and QoS rules may include information such as media files, QR code, VLC sequences, plain text indicators, as previously described. Other context indicators may also be provided. The trusted context engine (TCE) may be configured to compare a module input to the context indicators and then apply the appropriate QoS transformation to the module input. The module output may be based on the module input and the QoS transformation.

For example, in the navigation use case described in FIG. 11, the geofenced area 1106 may be programmed in the TCE based on input from the edge server 1202 and/or a privileged application executing on the UE 1200. The TCE may have access to the data that is needed to determine the geofence accurately, such as range measurements provided by the SPS receiver 217, cellular and/or WiFi measurements based on signals received by the transceiver 215. The TCE may also be configured with other user/operator preferences such as whether the UE 1200 is part of a designated target set or non-target set (e.g., employee or visitor, etc.). When the UE 1200 is outside of the geofenced area 1106, the TCE is configured to provide accurate assistance data, cell and/or WiFi measurements to a navigation module (e.g., a GNSS Position Engine). After determining that the UE 1200 device is within the geofenced area 1106, the TCE may be configured to determine if the assistance data provided to the navigation module is accurate assistance data or a corrupted version of the assistance data, cell and/or WiFi measurements. Based on the QoS rules, the TCE may be configured to modify the positioning measurements to reduce the accuracy of the position estimates provided to other applications on the UE 1200.

In the optical module use case described in FIG. 7A, the UE 1200 may be configured to receive image files associated with the paintings 702, 704 (or other context indicator data) from the edge server 1202 with the TCE. The module input may be an image obtained with a camera. The TCE is configured to compare the image obtained with the camera with the image files received from the edge server 1202 and apply the QoS rules to transform the camera image. The module output may be a low quality image, redacted image, blank image, watermarked image file (e.g., with DRM features added), or other transformation of the camera input (or captured image file) based on the QoS rules. The module output may be further processed by the HLOS 1206, such as being stored in memory or presented on a device display.

The UE 1200 and edge server 1202 are examples, and not limitations, as other communication and data processing techniques may be used to obtain context indicators and QoS rules, and then apply the corresponding QoS transformations to a module input.

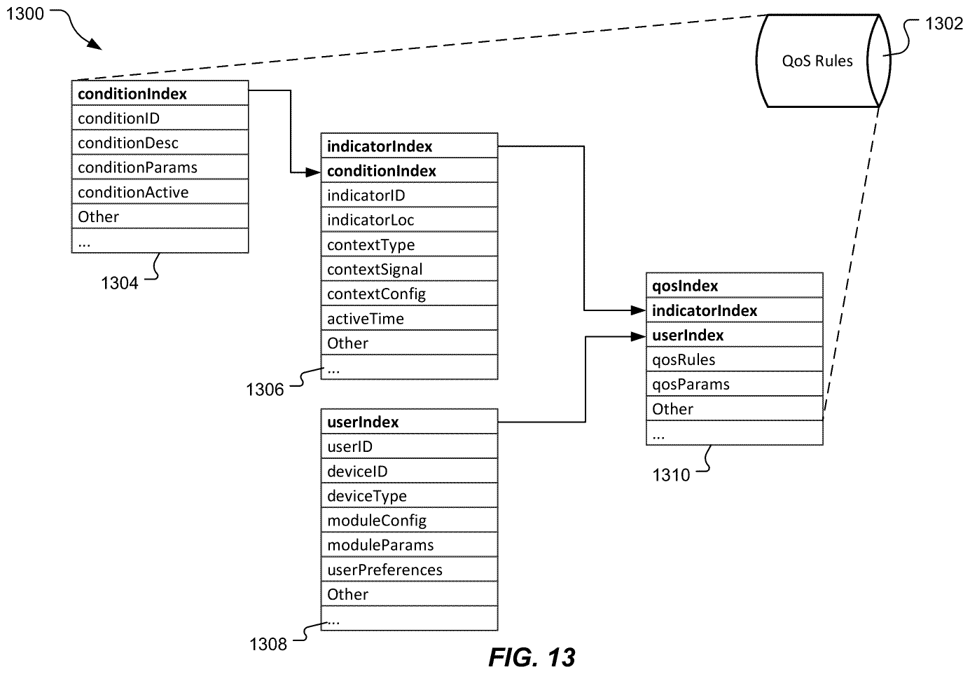

Referring to FIG. 13, an example data structure 1300 for implementing context base quality of service rules is shown. The data structure 1300 may persist on the edge server 1202, on another networked server 400 such as the LMF 120, or on a UE 200. The data structure 1300 may be disposed on a memory device 1302 such as a solid state or mechanical hard drive, and may include a plurality of data records stored in a relational database application (e.g., Amazon Aurora, Oracle Database, Microsoft SQL Server, MySQL, DB2, etc.), or stored in one or more flat files (e.g., JSON, XML, CSV, etc.), or other accessible arrays in the memory device 1302. The table structures and fields in the data structure 1300 are examples, and not a limitation, as other data fields, tables, stored procedures and indexing schemas may be used to construct the data structure 1300. In an example, the data structure 1300 may include a conditions table 1304, an indicator table 1306, a user table 1308, and a QoS rules table 1310. The conditions table 1304 may include fields associated with context conditions 602 detected by a mobile device or other networked resource (e.g., the edge server 1202, the LMF 120, etc.). For example, a conditionIndex and/or conditionID fields may be used to index the condition records in the conditions table 1304. A conditionDesc field may provide a plain text description of a condition record. One or more conditionParams fields may include operational parameters or conditions required to satisfy the condition. For example, as provided in the use cases herein, the parameters may include location information, UE state information, application information (e.g., ticket purchase, schedule item), or other parameters to anticipate the use of proximate context indicators. A conditionsActive field may include date/time information indicating when the condition may apply. These fields are examples, and not limitations as other fields and related tables may also be included in the conditions table 1304. The indicator table 1306 may include fields associated with context indicators 604 a mobile device may detect. For example, an indicatorindex and/or indicatorid fields may be used to index the indicator records in the indicator table 1306. The records in the indicator table 1306 may reference records in the conditions table 1304 via one or more referential links. An indicatorLoc field may include location information for a context indicator (e.g., coordinates, address, room number, etc.). A contextType field may be used to categorize the types of context indicators (e.g., image, QR code, plain text, audio, VLC, location, etc.). A contextSignal field may be used to indicate the content of the context indicator (e.g., image file, QR code content, plain text word, audio file, VLC signal, location parameters, etc.). One or more contextConfig fields may include additional parametric information to describe the configuration of the indicator which may enable mobile devices to detect it. An activeTime field may include date/time information to indicate when the context indicator is active and detectable. These fields are examples, and not limitations as other fields and related tables may be included in the indicator table 1306.

The user table 1308 may include fields associated with user/operator preferences 608 which may impact the QoS rules. A userindex and/or userID fields may be used to index the records in the user table 1308. A deviceID field may include identification information associated with a particular mobile device, and a deviceType field may be used to categorize the type of device. One or more moduleConfig and moduleParams fields may include device/module specific parameters which may be modified based on the QoS rules. For example, the moduleConfig and moduleParams fields may be associated with the module hardware and/or software settings 610. One or more userPreferences fields may include information associated with a user's privileges and/or status (e.g., museum donor, employee, studentID, etc.) and other information associated with a user's preferences for applying QoS rules. These fields are examples, and not limitations as other fields and related tables may be included in the user table 1308. The QoS rules table 1310 may include fields associated with the QoS rules 606 which may be applied to modify the output of the modules within a mobile device. The QoS rules table 1310 may reference records in the indicator table 1306 and the user table 1308 via referential links. One or more qosRules fields may include operators and logic fields defining a QoS rule for a combination of a context indicator and a user and/or user preference. One or more qosParams fields may include the parameter values to enable a module to comply with a QoS rule. For example, a QoS rule may indicate to reduce the resolution of an image when a context indicator is detected and the qosParams fields may include parameters or functions to reduce the resolution of an image. Other use cases will utilize different rules and associated parameters. These fields are examples, and not limitations as other fields and related tables may be included in the QoS rules table 1310.

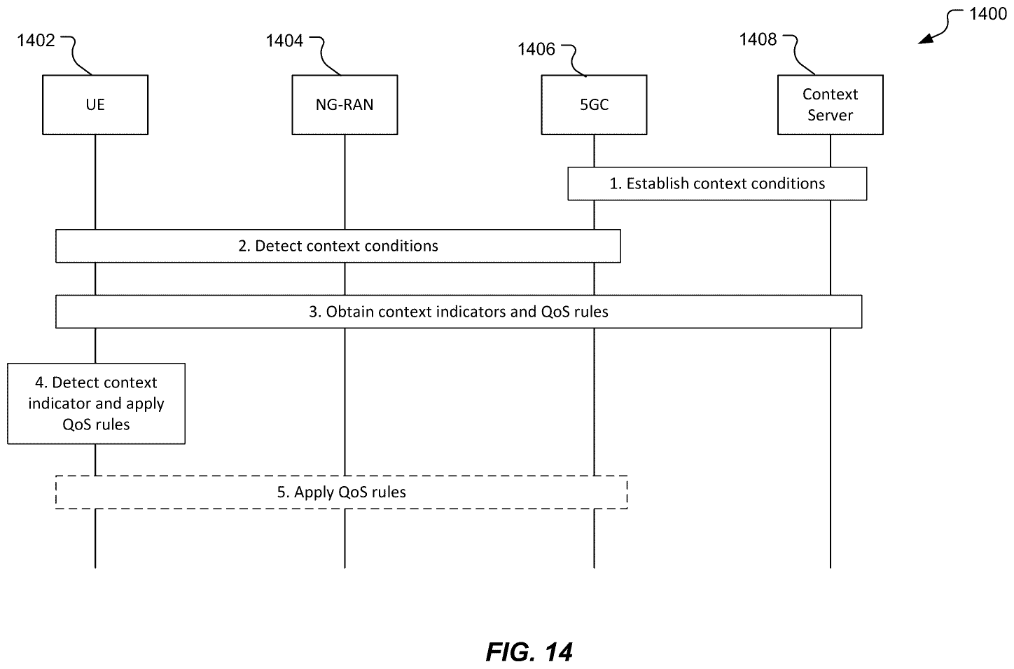

Referring to FIG. 14, an example message flow 1400 for providing contextual quality of service information to a user equipment is shown. The message flow 1400 includes a UE 1402, such as the UE 200, in a cellular communications network such as the communication network 100. The UE 1402 may communicate with network resources in a 5G core (5GC) 1406 via one or more stations (e.g., gNB, ng-eNB) in a NG-RAN 1404. The 5GC 1406 may include the LMF 120, AMF 115, and other networked servers. A context server 1408, such as the edge server 1202 or an external client 130, may be communicatively couple to the 5GC 1406 and configure to provide contextual quality of service information to the UE 1402 and other networked resources. The context server 1408 may be a web based service or microservice, and the UE 1402 may be configured to send and receive information from the context server 1408 via the internet. While FIG. 14 depicts message flows in a 5G cellular network, the disclosure is not so limited as the message flow 1400 may use other communication networks and protocols such as LTE, WiFi and Bluetooth. The message flow 1400 may include multiple steps with each step including one or more messages between two or more networked entities. For example, in a first step the context server 1408 and the 5GC may exchange messages to establish context conditions. The context conditions may be location based, application based, temporally based, event based, or other detectable conditions indicating that a mobile device may be in a position to detect a context indicator. The context conditions may persist in one or more data structures, such as the data structure 1300, and the context conditions may be provided to a communications network on demand and/or on a periodic basis.

In a second step, the communications network and/or the UE 1402 may be configured to detect one or more context conditions. As previously described, the context conditions may be based on location information (e.g., entering a geofence area or other designated area, proximity to a target UE, etc.), event and/or application based (e.g., purchasing tickets to a venue, subscribing to a service, new user setup on a corporate network, purchasing a media file, etc.), and other conditions which may anticipate the use of context indicators. For example, the LMF 120 in the 5GC 1406 may be configured to determine a location of the UE 1402 and detect a context condition based on the location. The context conditions may be provided to the UE 1402 via network messaging such as NAS (LPP/NPP), RRC, or other signaling techniques as known in the art, and the UE 1402 may be configured to send one or more signals to the network when a context condition is detected. For example, an application executing on the UE 1402 may provide an indication when a ticket to a venue (e.g., music concert, museum exhibit, etc.), or other context condition is satisfied.

In a third step, the context server 1408 (or other network resource) may be configured to obtain the context indicators and QoS rules based at least in part on the detected context condition. For example, one or more records of the data structure 1300 may be provided to the UE 1402 via transportable formats such as XML, JSON, CSV, etc. Other formats (e.g., text, binary) may also be used to provide the context indicators and QoS rules. In an example, the context indicators and/or QoS rules may be part of a dynamic link library (DLL), or other shared library, or compiled functions configured to execute on the UE 1402 based on inputs received by the UE 1402. In a fourth step, the UE 1402 is configured to detect one or more of the received context indicators and apply the corresponding QoS rules and described herein. Other information associated with the QoS rules, such as user and operator preferences may also be received and applied by the UE 1402. For example, referring to FIG. 7C, the first and second UEs 760, 762 may each receive context indicator and QoS rules from a network such that the image of a painting (e.g., the context indicator) may result in stored images of different quality (e.g., different QoS rules for the different UEs/users).

In an optional fifth step, the communication network including the NG-RAN 1404 and/or the 5GC 1406 may be configured to apply constraints or other process variations based at least in part on the QoS rules. For example, a QoS rule may include watermarking media files for images, videos, audio segments captured by the UE 1402. One or more servers in the communication network, or associated with other platforms such as social networks, may be configured to limit or otherwise constrain the propagation of the watermarked media files. In an example, network servers may be configured to redact or otherwise degrade the quality of a media file when a user attempts to post (e.g., distribute) the media file on a website or within a social media environment. In an example, the one or more servers in the NG-RAN 1404, the 5GC 1406, or with a social media platform may be configured to detect a context indicator in a media file obtained by the UE 1402 and apply the QoS rules before allowing the media file to be propagated. The networks may be configured to take other actions based on detecting a context indicator and the corresponding QoS rules.

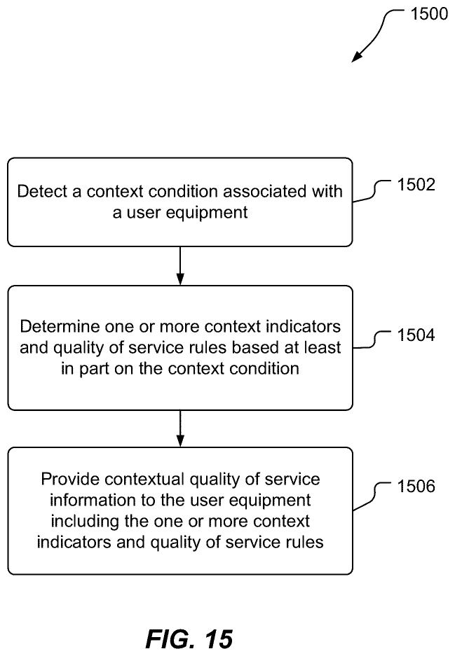

Referring to FIG. 15, with further reference to FIGS. 1-14, a method 1500 for providing contextual quality of service information includes the stages shown. The method 1500 is, however, an example and not limiting. The method 1500 may be altered, e.g., by having stages added, removed, rearranged, combined, performed concurrently, and/or having single stages split into multiple stages.

At stage 1502, the method includes detecting a context condition associated with a user equipment. A server 400, such as the LMF 120 and the edge server 1202, including a processor 410 and a transceiver 415, is a means for detecting a context condition associated with a UE. In an example, the server 400 may be configured to determine a location of the UE based on satellite and/or terrestrial positioning methods. For example, the LMF 120 may be configured to initiate a positioning session with the UE to obtain a location estimate of the UE. In an example, the UE may be configured to detect a context condition and provide the server 400 an indication that the context condition is satisfied. For example, the UE may provide one or more messages indicating that a ticket to a venue has been purchased, network credentials have been established, a media file was purchased, or other condition indicating that the UE may be proximate to one or more context indicators.

At stage 1504, the method includes determining one or more context indicators and quality of service rules based at least in part on the context condition. The server 400, including the processor 410 and the transceiver 415, is a means for determining one or more context indicators and QoS rules. In an example, the server 400 may include the data structure 1300 and may be configured to query the data structure 1300 based on the context condition detected at stage 1502. In an example, the server 400 may be configured to query a webservice API, or a microservice, based on the detected context condition to obtain the context indicators and QoS rules. Referring to FIG. 7A, in the optical use case, the context condition may be that a UE enters, or purchases a ticket to enter, an art museum, and the context indicators may include image or other data files associated with the art in the museum to enable the UE to recognize the art in a captured image. The QoS rules may cause an image to be captured or saved at a lower resolution, or other transformations as previously described.

At stage 1506, the method includes providing contextual quality of service information to the user equipment including the one or more context indicators and quality of service rules. The server 400, including the processor 410 and the transceiver 415, is a means for providing the contextual quality of service information. In an example, the server 400 may provide the query results obtained at stage 1504 to the UE via one or more cellular signaling techniques such as via LPP and RRC messages. WiFi and Bluetooth messaging may also be used to provide the contextual quality of service information to the UE. In an example, web based formats such as XML and JSON may be used to provide the quality of service information to the UE. Other data transport techniques as known in the art may also be used.

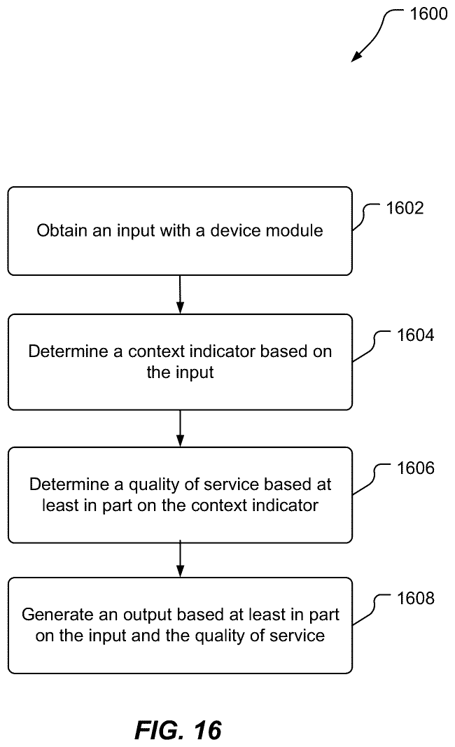

Referring to FIG. 16, with further reference to FIGS. 1-14, a method 1600 for generating an output based at least in part on contextual quality of service information includes the stages shown. The method 1600 is, however, an example and not limiting. The method 1600 may be altered, e.g., by having stages added, removed, rearranged, combined, performed concurrently, and/or having single stages split into multiple stages.

At stage 1602, the method includes obtaining an input with a device module. A UE 200, including hardware and software modules such as an optical module 502, an acoustic module 504, a communications module 506, and a navigation module 508, is a means for obtaining an input. The input may be an image/video, audio, communication signal (e.g., detecting a radio signal transmitted from a base station), and/or navigation signals associated with terrestrial and satellite navigation techniques.

At stage 1604, the method includes determining a context indicator based on the input. The UE 200 and the corresponding modules 502, 504, 506, 508 are means for determining the context indicator. In an example, referring to FIG. 12, the UE 1200 may detect a context condition and request the context indicators and QoS rules from the edge server 1202, LMF 120, or other network entity. The context indicators and QoS rules may include information such as media files, QR code, VLC sequences, plain text indicators, as described herein. The TCE may be configured to compare the input received at stage 1602 to the received context indicators to determine whether the context indicator is present in the input. For example, image and audio recognition techniques may be used for optical and acoustic inputs. Other comparison functions, such as determining a current location relative to a context indicator comprising a predefined geofence area. Other comparison and analysis techniques may be used to determine if a context indicator is present in the input.

At stage 1606, the method includes determining a quality of service based at least in part on the context indicator. The UE 200 and the corresponding modules 502, 504, 506, 508 are means for determining the QoS. In an example, the context indicator and the QoS may be based on a relationship in the data structure 1300. The context indicator information and corresponding QoS rules may be provided based on a detected context condition. Other factors, such as user/operator preferences may also impact the QoS rules. For example, some users may be afforded preferential treatment based on a subscription service, a user status (e.g., club member, student, faculty, employee), or other operational considerations. In an example, some context indicators and QoS rules may be included in the memory 211 and configured at the time of manufacture (or via software updates) by an equipment manufacturer. For example, a universal context indicator, such as specific VLC sequences or codes, and QoS rules may be used by law enforcement vehicles at an accident scene to prevent unauthorized photographs of the accident scene and/or victims. Such universal and industry accepted standard context indicators may be included during device design and manufacture.

At stage 1608, the method includes generating an output based at least in part on the input and the quality of service. The UE 200 and the corresponding modules 502, 504, 506, 508 are means for generating an output. In an example, referring to FIG. 12, the TCE may be configured to compare a module input to the context indicators and then apply the appropriate QoS transformation to the module input. The module output may be based on the module input and the QoS transformation. The QoS transformations may be based on the use cases described herein, or based on other algorithms configured to alter the quality of a module input.

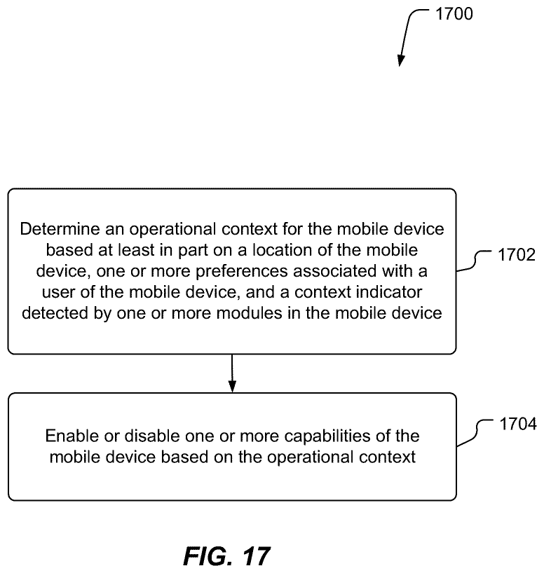

Referring to FIG. 17, with further reference to FIGS. 1-14, a method 1700 for enabling or disabling one or more capabilities of a mobile device includes the stages shown. The method 1700 is, however, an example and not limiting. The method 1700 may be altered, e.g., by having stages added, removed, rearranged, combined, performed concurrently, and/or having single stages split into multiple stages.

At stage 1702, the method includes determining an operational context for the mobile device based at least in part on a location of the mobile device, one or more preferences associated with a user of the mobile device, and a context indicator detected by one or more modules in the mobile device. A UE 200, including hardware and software modules such as the processors 210, an optical module 502, an acoustic module 504, a communications module 506, and/or a navigation module 508, is a means for determining an operational context for the mobile device. In an example, the location of the mobile device may be based on one or more terrestrial and/or satellite navigation techniques. The one or more preferences associated with the user may be stored in a data structure 1300 in the local memory 211 or on a network memory device. the preferences may be an indication of privileges associated with the user, such as a VIP donor, ticket holder, etc. The preferences may also be used to indicate a status of a the user, such as a current student, employee, faculty, etc. In general, the preferences may be used to enable different functionality of mobile devices associated with different users. The one or more modules may include at least one of an optical module, an acoustic module, a communications module, and a navigation module. In an example, the context indicator detected by the one or more modules may be contained in an image obtained by a camera. The image may include at least one of a plain text indicator, a quick response code, and a visual light communication emitting device. An image file of the image may be transformed and stored such that a resolution of the image file may be based at least in part on the operational context. In an example, the context indicator detected by the one or more modules may be an acoustic input. The context indicator may be an audio component within the acoustic input, and an audio file may be stored in the memory 211 based on the acoustic input, such that a sampling rate of the audio file is based at least in part on the operational context. In an example, the context indicator detected by the one or more modules may include one or more radio frequency signals associated with terrestrial or satellite navigation.

The operational context may be based on the application of one or more quality of service rules based on the location of the mobile device, the user preferences, one or more context indicators, and/or combinations thereof. The one or more quality of service rules may be configured to reduce the capabilities of one or more modules in the mobile device as described herein. For example, the resolution of images, audio recordings, and position estimates may be reduced or otherwise limited based one the application of the quality of service rules.

At stage 1704, the method includes enabling or disabling one or more capabilities of the mobile device based on the operational context. The UE 200, including the processor 210, is a means for enabling or disabling one or more capabilities. The UE 200 may be configured to disable one or more of an optical module, an acoustic module, a communications module, and/or a navigation module based on the operational context. For example, an image capture/video recording capability may be disabled, a audio recording capability may be disabled, communications may be disabled, and/or navigation processes may be disabled. In an example, a quality of service of an enabled capability of the mobile device may be reduced based on the operational context. For example, the resolution of images, audio clips, communication bandwidth, and/or navigational accuracy may be reduced. Other capabilities of a mobile device may also be reduced based on the operational context. In an example, context indicator information may be received from a remote server based at least in part on the location of the mobile device and the one or more preferences associated with the user of the mobile device. The one or more preferences may be an indication of user privileges such as paying for a membership, purchasing a ticket, or other traceable events that may be used to classify different users.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:
Clause 1. A method of generating an output based on a contextual quality of service, comprising: obtaining an input with a device module; determining a context indicator based on the input; determining a quality of service based at least in part on the context indicator; and generating the output based at least in part on the input and the quality of service.
Clause 2. The method of clause 1 wherein the device module is an optical module and the input is an image.
Clause 3. The method of clause 2 wherein the context indicator is an object in the image.
Clause 4. The method of clause 3 wherein the object in the image is one or more of a plain text indicator, a quick response code, a visual light communication emitting device, or any combinations thereof.
Clause 5. The method of clause 1 wherein the device module is an acoustic module and the input is an acoustic input.
Clause 6. The method of clause 5 wherein the context indicator is an audio component within the acoustic input.
Clause 7. The method of clause 1 wherein the device module is a navigation module and the input includes radio frequency signals associated with terrestrial or satellite navigation.
Clause 8. The method of clause 7 wherein the context indicator is a position estimate based on the radio frequency signals.
Clause 9. The method of clause 1 further comprising: determining a context condition; and receiving context indicator information and quality of service rules based at least in part on the context condition.
Clause 10. The method of clause 9 wherein the context condition is one or more of a geofenced area, a schedule item, a network identifier, a user status, an application status, or any combinations thereof.
Clause 11. The method of clause 1 wherein generating the output includes applying a digital rights management feature to the output.
Clause 12. A method for providing contextual quality of service information, comprising: detecting a context condition associated with a user equipment; determining one or more context indicators and quality of service rules based at least in part on the context condition; and providing contextual quality of service information to the user equipment including the one or more context indicators and quality of service rules.
Clause 13. The method of clause 12 wherein detecting the context condition includes receiving an indication of the context condition from the user equipment.
Clause 14. The method of clause 12 wherein detecting the context condition includes determining a location of the user equipment.
Clause 15. The method of clause 12 wherein the contextual quality of service information is provided in one or more non-access stratum or radio resource control messages.
Clause 16. The method of clause 12 wherein the one or more context indicators and quality of service rules are associated with an optical module on the user equipment.
Clause 17. The method of clause 16 wherein the context condition is a geographic area and the one or more context indicators is one or more of a plain text indicator, a quick response code, a visual light communication emitting device, or any combinations thereof.
Clause 18. The method of clause 16 wherein the quality of service rules includes reducing a resolution of an image obtained with the optical module.
Clause 19. The method of clause 12 wherein the one or more context indicators and quality of service rules are associated with an acoustic module on the user equipment.
Clause 20. The method of clause 19 wherein the context condition is a duration of time and the one or more context indicators include an audio component within an acoustic input obtained with the acoustic module.
Clause 21. The method of clause 20 wherein the quality of service rules includes reducing a sample rate or limiting an audio bandwidth of the acoustic input obtained with the acoustic module.
Clause 22. The method of clause 12 wherein the one or more context indicators and quality of service rules are associated with a navigation module on the user equipment.
Clause 23. The method of clause 22 wherein the context condition is a time of day and the one or more context indicators includes a current location of the user equipment.
Clause 24. The method of clause 23 where in the quality of service rules includes reducing an accuracy of a location estimate for the user equipment.
Clause 25. The method of clause 12 wherein the one or more context indicators and quality of service rules are associated with a communications module on the user equipment.
Clause 26. The method of clause 12 further comprising: receiving a media file from the user equipment; detecting a context indicator in the media file; and applying a quality of service rule based on the context indicator.
Clause 27. A method of operating a mobile device, comprising: determining an operational context for the mobile device based at least in part on a location of the mobile device, one or more preferences associated with a user of the mobile device, and a context indicator detected by one or more modules in the mobile device; and enabling or disabling one or more capabilities of the mobile device based on the operational context.
Clause 28. The method of clause 27 wherein the one or more modules includes at least one of an optical module, an acoustic module, a communications module, and a navigation module.
Clause 29. The method of clause 27 further comprising reducing a quality of service of an enabled capability of the mobile device based on the operational context.
Clause 30. The method of clause 27 wherein the context indicator detected by the one or more modules is contained in an image obtained by a camera.
Clause 31. The method of clause 30 wherein the image includes at least one of a plain text indicator, a quick response code, a visual light communication emitting device, or any combination thereof.
Clause 32. The method of clause 30 further comprising storing a transformed image file of the image obtained by the camera, wherein a resolution of the transformed image file is based at least in part on the operational context.
Clause 33. The method of clause 27 wherein the context indicator detected by the one or more modules is an acoustic input.
Clause 34. The method of clause 33 wherein the context indicator is an audio component within the acoustic input.
Clause 35. The method of clause 33 further comprising storing an audio file based on the acoustic input, wherein a sampling rate of the audio file is based at least in part on the operational context.
Clause 36. The method of clause 27 wherein the context indicator detected by the one or more modules includes one or more radio frequency signals associated with terrestrial or satellite navigation.
Clause 37. The method of clause 27 further comprising receiving context indicator information from a remote server based at least in part on the location of the mobile device and the one or more preferences associated with the user of the mobile device.
Clause 38. The method of clause 27 wherein the one or more preferences include a privilege associated with the user.
Clause 39. The method of clause 27 wherein the one or more preferences include a status of the user.
Clause 40. The method of clause 27 wherein the enabling or the disabling of the one or more capabilities includes applying one or more quality of service rules associated with one or more of the location of the mobile device, the one or more preferences associated with the user of the mobile device, the context indicator, and any combinations thereof.
Clause 41. An apparatus, comprising: a memory; at least one transceiver; at least one processor communicatively coupled to the memory and the at least one transceiver, and configured to: obtain an input with a device module; determine a context indicator based on the input; determine a quality of service based at least in part on the context indicator; and generate an output based at least in part on the input and the quality of service.
Clause 42. The apparatus of clause 41 wherein the device module is an optical module and the input is an image.
Clause 43. The apparatus of clause 42 wherein the context indicator is an object in the image.
Clause 44. The apparatus of clause 43 wherein the object in the image is one or more of a plain text indicator, a quick response code, a visual light communication emitting device, or any combinations thereof.
Clause 45. The apparatus of clause 41 wherein the device module is an acoustic module and the input is an acoustic input.
Clause 46. The apparatus of clause 45 wherein the context indicator is an audio component within the acoustic input.
Clause 47. The apparatus of clause 41 wherein the device module is a navigation module and the input includes radio frequency signals associated with terrestrial or satellite navigation.
Clause 48. The apparatus of clause 47 wherein the context indicator is a position estimate based on the radio frequency signals.
Clause 49. The apparatus of clause 41 wherein the at least one processor is further configured to: determine a context condition; and receive context indicator information and quality of service rules based at least in part on the context condition.
Clause 50. The apparatus of clause 49 wherein the context condition is one or more of a geofenced area, a schedule item, a network identifier, a user status, an application status, or any combinations thereof.
Clause 51. The apparatus of clause 41 wherein the at least one processor is further configured to apply a digital rights management feature to the output.
Clause 52. An apparatus, comprising: a memory; at least one transceiver; at least one processor communicatively coupled to the memory and the at least one transceiver, and configured to: detect a context condition associated with a user equipment; determine one or more context indicators and quality of service rules based at least in part on the context condition; and provide contextual quality of service information to the user equipment including the one or more context indicators and quality of service rules.
Clause 53. The apparatus of clause 52 wherein the at least one processor is further configured to receive an indication of the context condition from the user equipment.
Clause 54. The apparatus of clause 52 wherein the at least one processor is further configured to determine a location of the user equipment.
Clause 55. The apparatus of clause 52 wherein the at least one processor is further configured to provide the contextual quality of service information in one or more non-access stratum or radio resource control messages.
Clause 56. The apparatus of clause 52 wherein the one or more context indicators and quality of service rules are associated with an optical module on the user equipment.
Clause 57. The apparatus of clause 56 wherein the context condition is a geographic area and the one or more context indicators is one or more of a plain text indicator, a quick response code, a visual light communication emitting device, or any combinations thereof.
Clause 58. The apparatus of clause 56 wherein the quality of service rules includes reducing a resolution of an image obtained with the optical module.
Clause 59. The apparatus of clause 52 wherein the one or more context indicators and quality of service rules are associated with an acoustic module on the user equipment.
Clause 60. The apparatus of clause 59 wherein the context condition is a duration of time and the one or more context indicators include an audio component within an acoustic input obtained with the acoustic module.
Clause 61. The apparatus of clause 60 wherein the quality of service rules includes reducing a sample rate or limiting an audio bandwidth of the acoustic input obtained with the acoustic module.
Clause 62. The apparatus of clause 52 wherein the one or more context indicators and quality of service rules are associated with a navigation module on the user equipment.
Clause 63. The apparatus of clause 62 wherein the context condition is a time of day and the one or more context indicators includes a current location of the user equipment.
Clause 64. The apparatus of clause 63 where in the quality of service rules includes reducing an accuracy of a location estimate for the user equipment.
Clause 65. The apparatus of clause 52 wherein the one or more context indicators and quality of service rules are associated with a communications module on the user equipment.
Clause 66. The apparatus of clause 52 wherein the at least one processor is further configured to: receive a media file from the user equipment; detect a context indicator in the media file; and apply a quality of service rule based on the context indicator.
Clause 67. An apparatus, comprising: a memory; at least one transceiver; at least one processor communicatively coupled to the memory and the at least one transceiver, and configured to: determine an operational context for a mobile device based at least in part on a location of the mobile device, one or more preferences associated with a user of the mobile device, and a context indicator detected by one or more modules in the mobile device; and enable or disable one or more capabilities of the mobile device based on the operational context.
Clause 68. The apparatus of clause 67 wherein the one or more modules includes at least one of an optical module, an acoustic module, a communications module, and a navigation module.
Clause 69. The apparatus of clause 67 wherein the at least one processor is further configured to reduce a quality of service of an enabled capability of the mobile device based on the operational context.
Clause 70. The apparatus of clause 67 wherein the context indicator detected by the one or more modules is contained in an image obtained by a camera.
Clause 71. The apparatus of clause 70 wherein the image includes at least one of a plain text indicator, a quick response code, a visual light communication emitting device, or any combination thereof.
Clause 72. The apparatus of clause 70 wherein the at least one processor is further configured to store an image file based on the image obtained by the camera, wherein a resolution of the image file is based at least in part on the operational context.
Clause 73. The apparatus of clause 67 wherein the context indicator detected by the one or more modules is an acoustic input.
Clause 74. The apparatus of clause 73 wherein the context indicator is an audio component within the acoustic input.
Clause 75. The apparatus of clause 73 wherein the at least one processor is further configured to store an audio file based on the acoustic input, wherein a sampling rate of the audio file is based at least in part on the operational context.
Clause 76. The apparatus of clause 67 wherein the context indicator detected by the one or more modules includes one or more radio frequency signals associated with terrestrial or satellite navigation.
Clause 77. The apparatus of clause 67 wherein the at least one processor is further configured to receive context indicator information from a remote server based at least in part on the location of the mobile device and the one or more preferences associated with the user of the mobile device.
Clause 78. The apparatus of clause 67 wherein the one or more preferences include a privilege associated with the user.
Clause 79. The apparatus of clause 67 wherein the one or more preferences include a status of the user.
Clause 80. The apparatus of clause 67 wherein the at least one processor is further configured to apply one or more quality of service rules associated with one or more of the location of the mobile device, the one or more preferences associated with the user of the mobile device, the context indicator, and any combinations thereof to enable or disable the one or more capabilities of the mobile device.
Clause 81. An apparatus for generating an output based on a contextual quality of service, comprising: means for obtaining an input with a device module; means for determining a context indicator based on the input; means for determining a quality of service based at least in part on the context indicator; and means for generating the output based at least in part on the input and the quality of service.
Clause 82. An apparatus for providing contextual quality of service information, comprising: means for detecting a context condition associated with a user equipment; means for determining one or more context indicators and quality of service rules based at least in part on the context condition; and means for providing contextual quality of service information to the user equipment including the one or more context indicators and quality of service rules.
Clause 83. A mobile device, comprising: means for determining an operational context for the mobile device based at least in part on a location of the mobile device, one or more preferences associated with a user of the mobile device, and a context indicator detected by one or more modules in the mobile device; and means for enabling or disabling one or more capabilities of the mobile device based on the operational context.
Clause 84. A non-transitory processor-readable storage medium comprising processor-readable instructions configured to cause one or more processors to generate an output based on a contextual quality of service, comprising code for: obtaining an input with a device module; determining a context indicator based on the input; determining a quality of service based at least in part on the context indicator; and generating the output based at least in part on the input and the quality of service.
Clause 85. A non-transitory processor-readable storage medium comprising processor-readable instructions configured to cause one or more processors to provide contextual quality of service information, comprising code for: detecting a context condition associated with a user equipment; determining one or more context indicators and quality of service rules based at least in part on the context condition; and providing the contextual quality of service information to the user equipment including the one or more context indicators and quality of service rules.
Clause 86. A non-transitory processor-readable storage medium comprising processor-readable instructions configured to cause one or more processors to operate a mobile device, comprising code for: determining an operational context for the mobile device based at least in part on a location of the mobile device, one or more preferences associated with a user of the mobile device, and a context indicator detected by one or more modules in the mobile device; and enabling or disabling one or more capabilities of the mobile device based on the operational context.

1. A method of generating an output based on a contextual quality of service, comprising:
obtaining an input with a device module;
determining a context indicator based on the input;
determining a quality of service based at least in part on the context indicator; and
generating the output based at least in part on the input and the quality of service.

2. The method of claim 1 wherein the device module is an optical module and the input is an image.

3. The method of claim 2 wherein the context indicator is an object in the image.

4. The method of claim 3 wherein the object in the image is one or more of a plain text indicator, a quick response code, a visual light communication emitting device, or any combinations thereof.

5. The method of claim 1 wherein the device module is an acoustic module and the input is an acoustic input.

6. The method of claim 5 wherein the context indicator is an audio component within the acoustic input.

7. The method of claim 1 wherein the device module is a navigation module and the input includes radio frequency signals associated with terrestrial or satellite navigation.

8. The method of claim 7 wherein the context indicator is a position estimate based on the radio frequency signals.

9. The method of claim 1 further comprising:
determining a context condition; and
receiving context indicator information and quality of service rules based at least in part on the context condition.

10. The method of claim 9 wherein the context condition is one or more of a geofenced area, a schedule item, a network identifier, a user status, an application status, or any combinations thereof.

11. The method of claim 1 wherein generating the output includes applying a digital rights management feature to the output.

12. A method for providing contextual quality of service information, comprising:
detecting a context condition associated with a user equipment;
determining one or more context indicators and quality of service rules based at least in part on the context condition; and
providing contextual quality of service information to the user equipment including the one or more context indicators and quality of service rules.

13. The method of claim 12 wherein detecting the context condition includes receiving an indication of the context condition from the user equipment.

14. The method of claim 12 wherein detecting the context condition includes determining a location of the user equipment.

15. The method of claim 12 wherein the contextual quality of service information is provided in one or more non-access stratum or radio resource control messages.

16. The method of claim 12 wherein the one or more context indicators and quality of service rules are associated with an optical module on the user equipment.

17. The method of claim 16 wherein the context condition is a geographic area and the one or more context indicators is one or more of a plain text indicator, a quick response code, a visual light communication emitting device, or any combinations thereof.

18. The method of claim 16 wherein the quality of service rules includes reducing a resolution of an image obtained with the optical module.

19. The method of claim 12 wherein the one or more context indicators and quality of service rules are associated with an acoustic module on the user equipment.

20. The method of claim 19 wherein the context condition is a duration of time and the one or more context indicators include an audio component within an acoustic input obtained with the acoustic module.

21. The method of claim 20 wherein the quality of service rules includes reducing a sample rate or limiting an audio bandwidth of the acoustic input obtained with the acoustic module.

22. The method of claim 12 wherein the one or more context indicators and quality of service rules are associated with a navigation module on the user equipment.

23. The method of claim 22 wherein the context condition is a time of day and the one or more context indicators includes a current location of the user equipment.

24. The method of claim 23 where in the quality of service rules includes reducing an accuracy of a location estimate for the user equipment.

25. The method of claim 12 wherein the one or more context indicators and quality of service rules are associated with a communications module on the user equipment.

26. The method of claim 12 further comprising:
receiving a media file from the user equipment;
detecting a context indicator in the media file; and
applying a quality of service rule based on the context indicator.

27. A method of operating a mobile device, comprising:
determining an operational context for the mobile device based at least in part on a location of the mobile device, one or more preferences associated with a user of the mobile device, and a context indicator detected by one or more modules in the mobile device; and
enabling or disabling one or more capabilities of the mobile device based on the operational context.

28. The method of claim 27 wherein the one or more modules includes at least one of an optical module, an acoustic module, a communications module, and a navigation module.

29. The method of claim 27 further comprising reducing a quality of service of an enabled capability of the mobile device based on the operational context.

30. The method of claim 27 wherein the context indicator detected by the one or more modules is contained in an image obtained by a camera.

31. The method of claim 30 wherein the image includes at least one of a plain text indicator, a quick response code, a visual light communication emitting device, or any combination thereof.

32. The method of claim 30 further comprising storing a transformed image file of the image obtained by the camera, wherein a resolution of the transformed image file is based at least in part on the operational context.

33. The method of claim 27 wherein the context indicator detected by the one or more modules is an acoustic input.

34. The method of claim 33 wherein the context indicator is an audio component within the acoustic input.

35. The method of claim 33 further comprising storing an audio file based on the acoustic input, wherein a sampling rate of the audio file is based at least in part on the operational context.

36. The method of claim 27 wherein the context indicator detected by the one or more modules includes one or more radio frequency signals associated with terrestrial or satellite navigation.

37. The method of claim 27 further comprising receiving context indicator information from a remote server based at least in part on the location of the mobile device and the one or more preferences associated with the user of the mobile device.

38. The method of claim 27 wherein the one or more preferences include a privilege associated with the user.

39. The method of claim 27 wherein the one or more preferences include a status of the user.

40. The method of claim 27 wherein the enabling or the disabling of the one or more capabilities includes applying one or more quality of service rules associated with one or more of the location of the mobile device, the one or more preferences associated with the user of the mobile device, the context indicator, and any combinations thereof.

41. An apparatus, comprising:
a memory;
at least one transceiver;
at least one processor communicatively coupled to the memory and the at least one transceiver, and configured to:
obtain an input with a device module;
determine a context indicator based on the input;
determine a quality of service based at least in part on the context indicator; and
generate an output based at least in part on the input and the quality of service.

42. The apparatus of claim 41 wherein the device module is an optical module and the input is an image.

43. The apparatus of claim 42 wherein the context indicator is an object in the image.

44. The apparatus of claim 43 wherein the object in the image is one or more of a plain text indicator, a quick response code, a visual light communication emitting device, or any combinations thereof.

45. The apparatus of claim 41 wherein the device module is an acoustic module and the input is an acoustic input.

46. The apparatus of claim 45 wherein the context indicator is an audio component within the acoustic input.

47. The apparatus of claim 41 wherein the device module is a navigation module and the input includes radio frequency signals associated with terrestrial or satellite navigation.

48. The apparatus of claim 47 wherein the context indicator is a position estimate based on the radio frequency signals.

49. The apparatus of claim 41 wherein the at least one processor is further configured to:
determine a context condition; and
receive context indicator information and quality of service rules based at least in part on the context condition.

50. The apparatus of claim 49 wherein the context condition is one or more of a geofenced area, a schedule item, a network identifier, a user status, an application status, or any combinations thereof.

51. The apparatus of claim 41 wherein the at least one processor is further configured to apply a digital rights management feature to the output.

52. An apparatus, comprising:
a memory;
at least one transceiver;
at least one processor communicatively coupled to the memory and the at least one transceiver, and configured to:
detect a context condition associated with a user equipment;
determine one or more context indicators and quality of service rules based at least in part on the context condition; and
provide contextual quality of service information to the user equipment including the one or more context indicators and quality of service rules.

53. The apparatus of claim 52 wherein the at least one processor is further configured to receive an indication of the context condition from the user equipment.

54. The apparatus of claim 52 wherein the at least one processor is further configured to determine a location of the user equipment.

55. The apparatus of claim 52 wherein the at least one processor is further configured to provide the contextual quality of service information in one or more non-access stratum or radio resource control messages.

56. The apparatus of claim 52 wherein the one or more context indicators and quality of service rules are associated with an optical module on the user equipment.

57. The apparatus of claim 56 wherein the context condition is a geographic area and the one or more context indicators is one or more of a plain text indicator, a quick response code, a visual light communication emitting device, or any combinations thereof.

58. The apparatus of claim 56 wherein the quality of service rules includes reducing a resolution of an image obtained with the optical module.

59. The apparatus of claim 52 wherein the one or more context indicators and quality of service rules are associated with an acoustic module on the user equipment.

60. The apparatus of claim 59 wherein the context condition is a duration of time and the one or more context indicators include an audio component within an acoustic input obtained with the acoustic module.

61. The apparatus of claim 60 wherein the quality of service rules includes reducing a sample rate or limiting an audio bandwidth of the acoustic input obtained with the acoustic module.

62. The apparatus of claim 52 wherein the one or more context indicators and quality of service rules are associated with a navigation module on the user equipment.

63. The apparatus of claim 62 wherein the context condition is a time of day and the one or more context indicators includes a current location of the user equipment.

64. The apparatus of claim 63 where in the quality of service rules includes reducing an accuracy of a location estimate for the user equipment.

65. The apparatus of claim 52 wherein the one or more context indicators and quality of service rules are associated with a communications module on the user equipment.

66. The apparatus of claim 52 wherein the at least one processor is further configured to:
receive a media file from the user equipment;
detect a context indicator in the media file; and
apply a quality of service rule based on the context indicator.

67. An apparatus, comprising:
a memory;
at least one transceiver;
at least one processor communicatively coupled to the memory and the at least one transceiver, and configured to:
determine an operational context for a mobile device based at least in part on a location of the mobile device, one or more preferences associated with a user of the mobile device, and a context indicator detected by one or more modules in the mobile device; and
enable or disable one or more capabilities of the mobile device based on the operational context.

68. The apparatus of claim 67 wherein the one or more modules includes at least one of an optical module, an acoustic module, a communications module, and a navigation module.

69. The apparatus of claim 67 wherein the at least one processor is further configured to reduce a quality of service of an enabled capability of the mobile device based on the operational context.

70. The apparatus of claim 67 wherein the context indicator detected by the one or more modules is contained in an image obtained by a camera.

71. The apparatus of claim 70 wherein the image includes at least one of a plain text indicator, a quick response code, a visual light communication emitting device, or any combination thereof.

72. The apparatus of claim 70 wherein the at least one processor is further configured to store an image file based on the image obtained by the camera, wherein a resolution of the image file is based at least in part on the operational context.

73. The apparatus of claim 67 wherein the context indicator detected by the one or more modules is an acoustic input.

74. The apparatus of claim 73 wherein the context indicator is an audio component within the acoustic input.

75. The apparatus of claim 73 wherein the at least one processor is further configured to store an audio file based on the acoustic input, wherein a sampling rate of the audio file is based at least in part on the operational context.

76. The apparatus of claim 67 wherein the context indicator detected by the one or more modules includes one or more radio frequency signals associated with terrestrial or satellite navigation.

77. The apparatus of claim 67 wherein the at least one processor is further configured to receive context indicator information from a remote server based at least in part on the location of the mobile device and the one or more preferences associated with the user of the mobile device.

78. The apparatus of claim 67 wherein the one or more preferences include a privilege associated with the user.

79. The apparatus of claim 67 wherein the one or more preferences include a status of the user.

80. The apparatus of claim 67 wherein the at least one processor is further configured to apply one or more quality of service rules associated with one or more of the location of the mobile device, the one or more preferences associated with the user of the mobile device, the context indicator, and any combinations thereof to enable or disable the one or more capabilities of the mobile device.
